(19) United States
(12) Patent Application Publication
(10) Pub. No.: US 2008/0212238 A1
(43) Pub. Date: Sep. 4, 2008

(54) Magnetoresistive head with larger longitudinal biasing

(76) Inventors: Katsuro Watanabe, Ibaraki (JP); Satoru Okamoto, Kanagawa (JP); Masahiro Osugi, Kanagawa (JP); Koji Okazaki, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/012,341

(22) Filed: Jan. 31, 2008

(30) Foreign Application Priority Data
Jan. 31, 2007 (JP) 2007-007880

(51) Int. Cl. G11B 5/33

(52) U.S. Cl. 360/319

(57) ABSTRACT

Embodiments of the present invention help to efficiently apply a longitudinal biasing with appropriate strength from a longitudinal biasing layer to a free layer even in a small read gap length. According to one embodiment, in the track width direction of the magnetoresistive film, the longitudinal biasing layer excluding its portion close to the magnetoresistive film is made approximately uniform in thickness. An edge toward the magnetoresistive film of the longitudinal biasing layer is positioned more outwardly in the track width direction than an edge in the track width direction of the free layer. A portion closest to the substrate of the interface between the longitudinal biasing layer and the insulator on the track-width sides is positioned lower than the interface between the magnetoresistive film and the lower magnetic shield layer.

### CROSS-REFERENCE TO RELATED APPLICATION

The instant nonprovisional patent application claims priority to Japanese Patent Application No. 2007-007880 filed Jan. 31, 2007 and which is incorporated by reference in its entirety herein for all purposes.

### BACKGROUND OF THE INVENTION

Magnetoresistive sensors making use of a magnetoresistive effect in which electric resistance changes in response to changes in an external field, have been known as superior magnetic field sensors. They have been in practical use as read heads in magnetic heads which are primary components of magnetic storage apparatuses. With magnetic storage apparatuses growing smaller, performance improvement is also required of magnetic heads which are used to read and write information. In terms of read heads, targets to be addressed include higher output and higher areal density. As for higher output, development and improvement of magnetoresistive films have been made. Anisotropic magnetoresistive (AMR) film was in use for a recording density of up to about 3×10⁸ bits per cm². For higher recording densities, giant magnetoresistive (GMR) film which makes higher output power available was developed and, since then, the GMR film has been improved. For as high a recording density as 9.3×10⁹ bits per cm², however, it is feared that even the GMR film will not provide enough output. Hence, research and development has been conducted on next generation magnetoresistive films such as the tunneling magnetoresistive (TMR) film as described in Journal of Magnetism and Magnetic Materials, vol. 139, pp. L231-L234 (1995) and the CPP-GMR film as described in Journal of Applied Physics, vol. 89, pp. 6943-6945 (2001). In these films, a sensing current is made to flow through a laminate of GMR films.

A magnetic head using the AMR film or GMR film as a magnetoresistive film and a magnetic head using the TMR film or CPP-GMR film as a magnetoresistive film largely differ in structure. The former has a CIP (current into the plane) structure in which a sensing current is made to flow in-plane through a magnetoresistive film formed of the AMR film or GMR film with electrodes for supplying the sensing current provided on both sides of the magnetoresistive film. The latter has a CPP structure in which a sensing current is made to flow approximately perpendicularly to the stacking surface of the magnetoresistive film which is formed of the TMR film or CPP-GMR film, with electrodes for supplying the sensing current layered over the magnetoresistive film.

The magnetoresistive film used in the magnetic head, whether of the former type or of the latter type, includes a magnetic layer (free layer) for changing the direction of magnetization depending on the magnitude of a magnetic field applied by a recording medium. Generally, the magnetic head is provided with a longitudinal biasing layer to suppress instability phenomena, for example, Barkhausen noise, attributable to unstable magnetization behavior. Regarding the shape along the track width direction of the longitudinal biasing layer included in a magnetic head having a CPP structure, in each of the shapes disclosed in Japanese Patent Publication No. 2004-253593 (“Patent Document 1”) and Japanese Patent Publication No. 2004-241763 (“Patent Document 2”), respectively, the thickness of the longitudinal biasing layer is gradually smaller toward the magnetoresistive film.

In a magnetic head having a CPP structure, a sensing current is, as described above, made to flow through a magnetoresistive film approximately perpendicularly to the film surface, so that it is necessary to provide a longitudinal biasing layer on each side of the magnetoresistive film via a insulator on the track-width sides. A problem unique to the magnetic head having a CPP structure is that the CPP structure increases the distance between the free layer and the longitudinal biasing layer, weakening the generated longitudinal biasing to be generated. In the magnetic head having a CPP structure, to secure a longitudinal biasing required to suppress the above instability phenomenon, it is necessary to make the longitudinal biasing layer adequately thick, particularly, in its portions close to both sides of the magnetoresistive film. Furthermore, it is also necessary to control the shape of the longitudinal biasing layer so that the magnetic field generated by the longitudinal biasing layer is efficiently applied to the magnetic layer that changes the direction of magnetization according to the magnitude of the magnetic field applied from the recording medium.

In the magnetic head described in Patent Document 1, the thickness of the longitudinal biasing layer is gradually smaller toward the magnetoresistive film with the longitudinal biasing layer and the magnetoresistive film in direct contact. This means that the longitudinal biasing layer is required to be formed of an insulating material. In the magnetic head described in Patent Document 2, the thickness of the longitudinal biasing layer is also gradually smaller toward the magnetoresistive film. In the latter case, however, the lower electrode layer and the lower magnetic shield layer each have a flat upper surface. Also, the edge of the longitudinal biasing layer, facing the magnetoresistive film, is positioned more inwardly, in the track width direction, than the edge on the corresponding side of the free layer. In such a structure, as being described later, it is considered difficult to maintain appropriate longitudinal biasing, particularly, in a small shield-to-shield distance (read gap length).

### BRIEF SUMMARY OF THE INVENTION

Embodiments of the present invention help to efficiently apply a longitudinal biasing with appropriate strength from a longitudinal biasing layer to a free layer even in a small read gap length.

According to the particular embodiment of FIG. 1, in the track width direction of the magnetoresistive film, the longitudinal biasing layer (20) excluding its portion close to the magnetoresistive film, is made approximately uniform in thickness. An edge toward the magnetoresistive film of the longitudinal biasing layer (20) is positioned more outwardly in the track width direction than an edge in the track width direction of the free layer (16). A portion closest to the substrate of the interface between the longitudinal biasing layer (20) and the insulator on the track-width sides (22) is positioned lower than the interface between the magnetoresistive film and the lower magnetic shield layer (11).

### BRIEF DESCRIPTION OF THE DRAWINGS

FIG. 1 is a schematic diagram showing the air bearing surface of a magnetoresistive head having a CPP structure according to embodiments of the present invention.

FIGS. 2(a)-2(c) show schematic diagrams showing the air bearing surfaces of magnetoresistive heads on which longitudinal bias field calculations were made, the magnetoresistive heads including the magnetoresistive head according to embodiments of the present invention and conventional magnetoresistive heads having a conventional CPP structure.

FIG. 3 is a diagram showing results of longitudinal bias field calculations made on the magnetoresistive head according to embodiments of the present invention and the conventional magnetoresistive heads having a CPP structure.

FIGS. 4(a) and 4(b) show schematic diagrams showing the air bearing surfaces of magnetoresistive heads on which longitudinal bias field calculations were made, the magnetoresistive heads including the magnetoresistive head according to embodiments of the present invention and a conventional magnetoresistive head having a CPP structure used as a sample for comparison purposes.

FIG. 5 is a diagram showing results of longitudinal bias field calculations made on the magnetoresistive head according to embodiments of the present invention and the conventional magnetoresistive head having a CPP structure used as a sample for comparison purposes.

FIG. 6 is a schematic diagram showing the air bearing surface of another magnetoresistive head having a CPP structure according to embodiments of the present invention.

FIGS. 7(a)-7(e) show diagrams showing a process flow scheme for forming the structure of a magnetic head in the track width direction according to embodiments of the present invention.

FIGS. 8(a)-8(e) show diagrams showing a process flow scheme for forming the structure of a conventional magnetic head in the track width direction.

FIGS. 9(a)-9(e) show diagrams showing a process flow scheme for forming the structure of a magnetic head in the track width direction according to embodiments of the present invention.

FIG. 10 is a diagram showing relationships between the longitudinal biasing strength at a track edge and coverage of the longitudinal biasing layer.

### DETAILED DESCRIPTION OF THE INVENTION

Embodiments of the present invention relate to a magnetoresistive head having a CPP (current perpendicular to the plane) structure in which a sensing current is made to flow through a stacking surface of a magnetoresistive film.

An object of embodiments of the present invention is to provide a magnetoresistive head in which instability phenomena, for example, Barkhausen noise, attributable to unstable magnetization behavior, are suppressed even in a small read gap length by making up for weakening of the longitudinal biasing attributable to the CPP structure of the head or by reinforcing the longitudinal biasing, thereby allowing the magnetoresistive head to exhibit stable read performance.

The magnetoresistive head according to embodiments of the present invention comprises a lower magnetic shield layer, an upper magnetic shield layer, a magnetoresistive film which is formed between the lower magnetic shield layer and the upper magnetic shield layer and which includes a film stack including a pinned layer, an intermediate layer, and a free layer, and a longitudinal biasing layer formed, via an insulator, on each side of the sensor film in a track width direction. In the magnetoresistive head: an edge facing the sensor film of the longitudinal biasing layer is positioned outer in the track width direction than an edge of the free layer in the track width direction; and the underside of the longitudinal biasing layer is, in an area separated from the sensor film in the track width direction, positioned lower than the underside of the sensor film.

The longitudinal biasing layer is approximately uniform in thickness over a portion thereof extending to a vicinity of the sensor film. A side wall of the sensor film in the track width direction has a concave shape, and the interface between the lower magnetic shield layer and the insulator is gently concave with an inclination continuous to the concave shape of the sensor film side wall.

Furthermore, the longitudinal biasing layer may have, in a portion thereof closer to the sensor film than a location thereof 40 nm away from an edge of the free layer in the track width direction, an upwardly convex upper contour and a downwardly convex lower contour. Still furthermore, the longitudinal biasing layer may have, over an edge thereof extending toward the sensor film from a location thereof 40 nm away from an edge of the free layer in the track width direction, an average height which does not differ more than 6 nm from the average height of the free layer. It is possible to provide a magnetoresistive head with a small read gap length by making the underside of the upper magnetic shield layer approximately flat and linear on an air bearing surface.

In the magnetoresistive head according to embodiments of the present invention, a large longitudinal biasing can be efficiently applied to a free layer from a longitudinal biasing layer provided, via a insulator on the track-width sides, on both sides of a magnetoresistive film, even in a small read gap length. Therefore, instability phenomena, for example, Barkhausen noise, attributable to unstable magnetization behavior are suppressed, and stable read performances are obtained.

In a magnetoresistive head, the biasing field applied to the free layer is affected by the shape of the longitudinal biasing layer. The head structure realized as a result of various dedicated studies conducted by the inventors and conventional head structures were compared by calculating the strength of the longitudinal biasing applied to the free layer in each of the head structures with the finite element method.

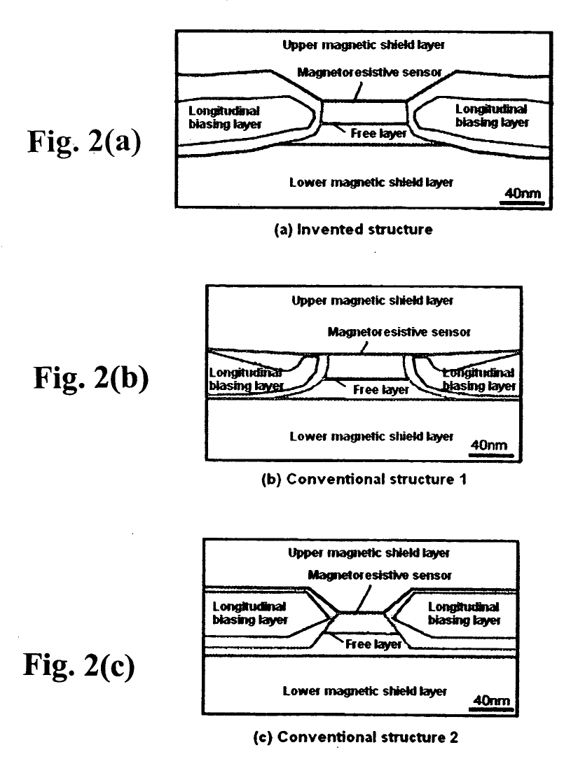

The magnetic head structure along the track width direction on an air bearing surface according to embodiments of the present invention, and those of conventional magnetic heads, are shown in FIG. 2. Namely, FIG. 2(a) shows the head structure (being described in detail later) according to embodiments of the present invention; FIG. 2(b) shows a conventional head structure 1 produced by a conventional method; and FIG. 2(c) shows a conventional head structure 2 as the one described in Patent Document 2. In the conventional head structure 1, the edge on each side, facing the side wall on the corresponding side of the sensor film, of the longitudinal biasing layer is upwardly curved along the side wall of the sensor film. The thickness of the edge of the longitudinal biasing layer is reduced in the vicinity of the sensor film causing the upper side of the longitudinal biasing layer to be concave where the thickness is reduced. In the conventional head structure 2, the thickness of the longitudinal biasing layer excluding its edge near the sensor film on each side is approximately uniform. In the edge near the sensor film, the thickness of the longitudinal biasing layer gradually decreases toward the sensor film thereby forming a sharp edge at its very end. The edged edge is positioned more inwardly toward the sensor film than the corresponding edge of the free layer. In each of the diagrams shown in FIG. 2, only the longitudinal biasing layer, lower magnetic shield layer, upper magnetic shield layer, and the free layer included in the magnetoresistive film that require to be considered in calculating longitudinal biasing strengths are shown.

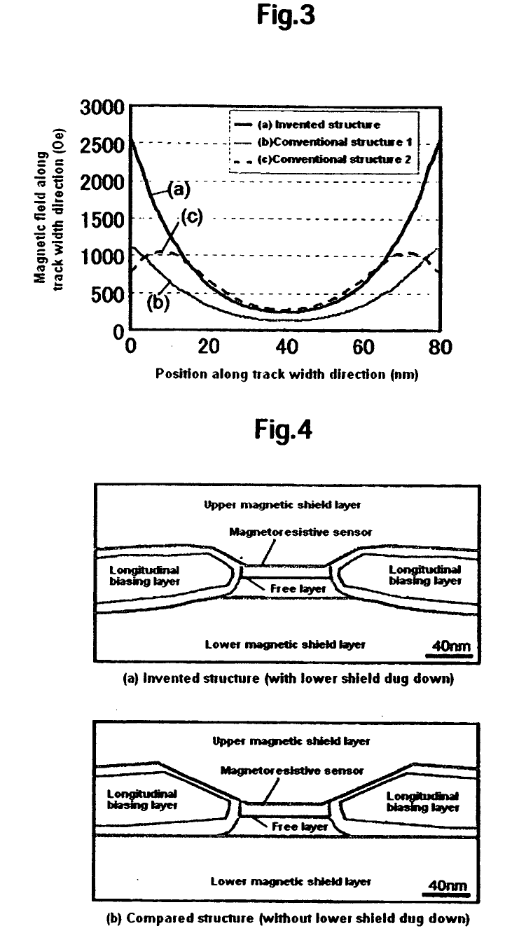

FIG. 3 shows the results of longitudinal bias field calculations made for the above three head structures based on the same conditions: a read gap length of 40 nm, a track width of 80 nm, and a magnetic moment, i.e. the product of the residual magnetic flux density and film thickness of the longitudinal biasing layer, of 360 G·μm. The track width refers to a width of the free layer along the track width direction. The magnetic field (a) in the head structure according to the present invention is the strongest at both track ends while monotonously weakening toward the track center portion. The strength of the magnetic field (b) in the conventional head structure 1 is distributed similarly to that of the magnetic field (a), but its strength at both track edges are as small as about two fifths that of the magnetic field (a). The magnetic field (c) in the conventional head structure 2 is stronger at a position a little inward of the track edge on each side than at each track edge. This is because, in the conventional head structure 2, the edge of the longitudinal biasing layer on each side facing the magnetoresistive film is positioned more inwardly than the corresponding edge of the free layer in the track width direction. In such a structure, part of the magnetic field generated from the edge on each side of the longitudinal biasing layer returns to the longitudinal biasing layer itself to weaken the longitudinal biasing applied to the free layer. When the magnetic field works in such a manner, the magnetization state becomes unstable at both track edges possibly causing magnetic domains to be generated.

With the magnetic field distribution in the track width direction being as described above, the free layer has a strong demagnetizing field in track edges, so that magnetization tends to become unstable at the track edges. It is therefore necessary to apply a stronger longitudinal biasing to the edges of the free layer to stabilize magnetization there. Furthermore, it is preferable that the distribution of magnetization monotonous change toward the track center. Thus, the head structure according to embodiments of the present invention as shown in FIG. 2(a), can be said a-preferable head structure.

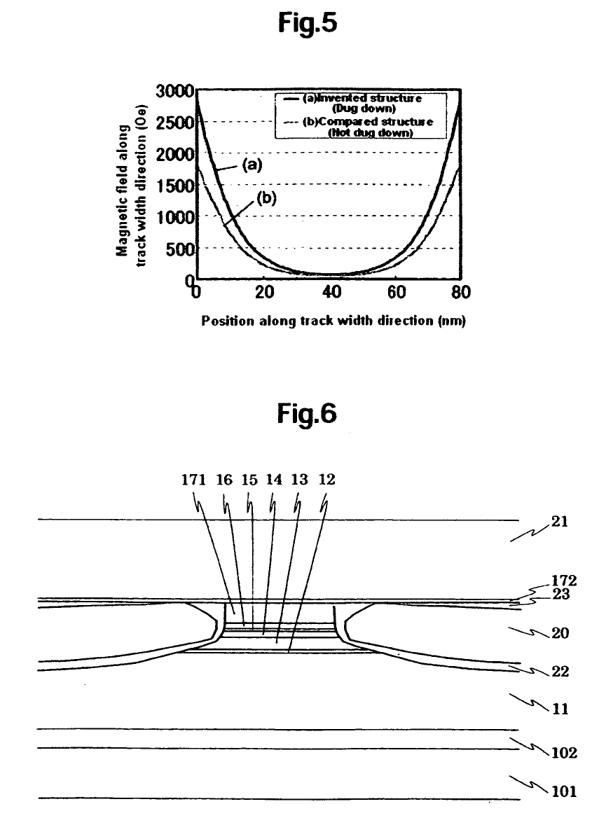

To realize a small read gap length, study was made on the longitudinal biasing generated with the lower magnetic shield layer dug by etching. For comparison purposes, similar longitudinal biasing calculations were made on magnetic heads with their lower magnetic shield layer left flat without being dug. FIG. 4(a) shows the head structure according to embodiments of the present invention. FIG. 4(b) shows a sample head structure produced for comparison. The calculations were made based on the conditions: a read gap length of 30 nm, a track width of 80 nm, and a magnetic moment of the longitudinal biasing layer of 360 G·μm. The calculation results are shown in FIG. 5. In both of the head structure (a) according to embodiments of the present invention and the sample head structure (b) for comparison, the magnetic field is distributed to be strong at track edges and to be monotonously weakened toward the track center. The magnetic field at each of the track edges of the head structure (a) is, however, 1.5 times stronger than that of the head structure (b), so that magnetization at the track edges can be made more stable in the head structure (a). In terms of the magnetic field strength at the track center, the head structures (a) and (b) are approximately the same, so that they are considered about the same in sensitivity toward an external field.

From what has been described above, it is known that the magnetic head structure according to embodiments of the present invention is a desirable one being stable in magnetization at track edges and sensitive, in track center portions, in responding to an external field.

Certain embodiments of the present invention will be described with reference to drawings.

### Embodiment 1

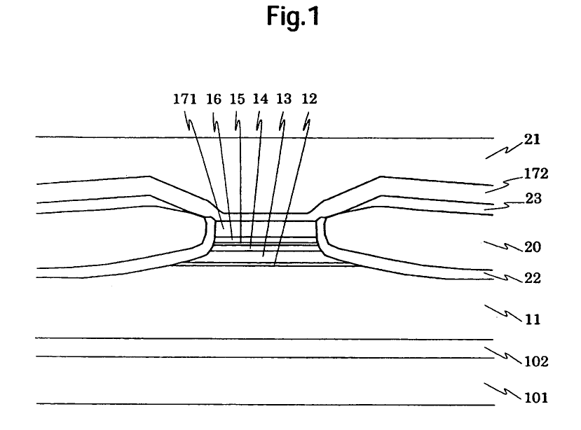

FIG. 1 shows the magnetoresistive head structure of a magnetoresistive film portion on the air bearing surface according to an embodiment of the present invention. A substrate 101, for example, made of a ceramic containing alumina and titanium carbide, is coated with an insulation film 102 of, for example, alumina. The coated surface of the substrate 101 is then planarized by fine polishing, and a lower magnetic shield layer 11 of, for example, a Ni—Fe alloy is formed on the coated surface. To be more concrete: a film which has been formed by, for example, a sputtering method, an ion beam sputtering method, or a plating method is patterned as predetermined; an insulator of, for example, alumina is formed all over the substrate; and its surface is then planarized by chemical mechanical polishing (CMP), making the patterned portion approximately as high as the peripheral insulator. In this process, control is also performed so that the surface roughness of the lower magnetic shield layer 11 does not exceed a predetermined roughness (center-line averaged roughness Ra not exceeding 1 nm).

Subsequently, after the cleaning is done in a deposition equipment to remove the surface oxidized layer formed on planarized surface, the following layers are formed over the lower magnetic shield layer 11 sequentially in the mentioned order: a lower gap layer 12, a pinning layer 13, a pinned layer 14 formed of a first ferromagnetic layer, an intermediate layer 15, a free layer 16 formed of a second ferromagnetic layer, and a first upper gap layer 171. The lower gap layer 12 and the first upper gap layer 171 are each formed of a Ta, Ru, Rh, Ni—Cr—Fe alloy or a film stack of such elements. The pinning layer 13 is formed of, for example, an antiferromagnetic film of, for example, a Pt—Mn alloy or Mn—Ir alloy, or a hard magnetic film of, for example, a Co—Pt alloy or Co—Cr—Pt alloy. The pinned layer 14 and the free layer 16 may be each formed of a Ni—Fe alloy, a Co—Fe alloy, a Co—Ni—Fe alloy, a high polarization material such as, for example, a magnetite or a Heusler alloy, or a film stack of such materials. A multilayer film in which ferromagnetic layers are laminated via spacer layers with a thickness of up to 1 nm may also be used. Magnetization of the pinned layer 14 is fixed in a direction by the pinning layer 13. The direction of magnetization of the free layer rotates by being affected by an external field.

In cases where a TMR effect is used, the intermediate layer 15 is a tunneling barrier. To be concrete, the tunneling barrier may be an oxide formed from Al, Mg, Si, Zr, or Ti, or an mixture of such elements, or a laminate of oxides of such elements. In cases where a CPP-GMR effect is used, the intermediate layer 15 is a conductive layer which may have a current-confined-path layer. To be concrete, the conductive layer may be formed of Al, Cu, Ag, or Au, or a mixture or laminate of such elements. In the conductive layer, a current-confined-path layer may be formed by partially oxidizing or nitriding such elements.

As described above, after the lower gap layer, the magnetoresistive film, and the first upper gap layer are formed, annealing with a magnetic field or setting in an external field is performed as required to align the magnetization of the ferromagnetic layer into a specific direction. Particularly, in cases where the pinning layer 13 is an antiferromagnetic film of, for example, a Pt—Mn alloy or Mn—Ir alloy having an ordered lattice, it is necessary to continue annealing in a magnetic field until an ordered stricture is formed in the pinning layer 13 causing exchange coupling to take place between the pinning layer 13 and the first ferromagnetic layer.

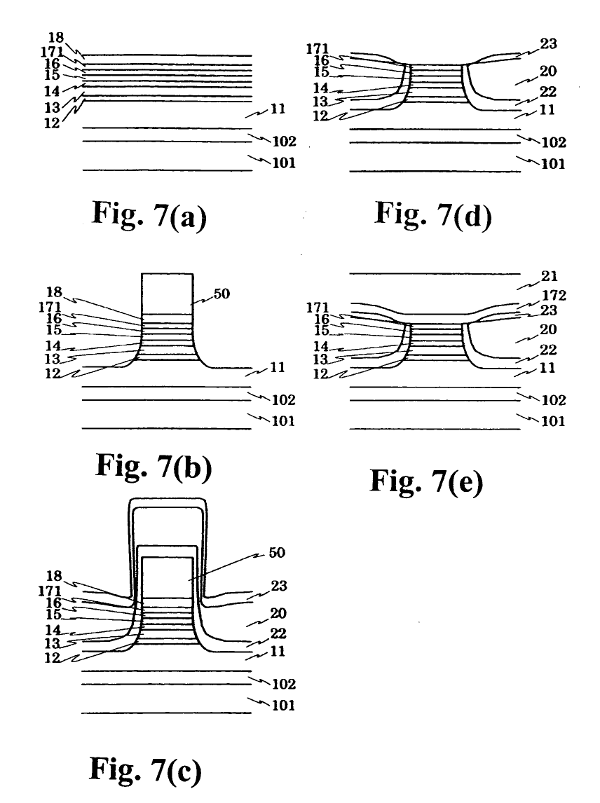

Next, a process for sensor formation in the track width direction will be described with reference to FIG. 7. After a process protection film on a magnetoresistive film 18 is formed as shown in FIG. 7(a), a lift-off mask 50 is formed over the area to be the sensor portion in the track width direction, and unrequired materials including unrequired portions of the magnetoresistive film are removed by etching as shown in FIG. 7(b). When doing this, it is important to perform etching without causing electric short-circuiting on the side walls of the magnetoresistive film portions that are left without being removed by etching. Such electric short-circuiting can be caused by re-deposited materials which come from the etched portions in the vicinity of the unremoved magnetoresistive film portions, or by irradiating the side walls with etching ions.

In preparation for a subsequent process in which a longitudinal biasing layer 20 is formed via a insulator on the track-width sides 22, etching is also performed to dig the lower magnetic shield layer 11 so that a longitudinal biasing layer with a thickness large enough to generate a required longitudinal biasing can be disposed to be approximately as high as the free layer 16 formed of a magnetoresistive film. Digging the lower magnetic shield layer 11 by etching so that, with the insulator on the track-width sides 22 formed, the lowest surface of the longitudinal biasing layer 20 is lower than the interface between the lower magnetic shield layer 11 and the lower gap layer 12 can reduce the difference between the height from the substrate surface of the film thickness center of the longitudinal biasing layer 20 and the height from the substrate surface of the free layer 16. This improves coverage of the longitudinal biasing layer 20, so that the magnetic flux leaking into the upper and lower magnetic shield layers can be reduced, making it possible to efficiently apply a longitudinal biasing to the free layer 16. Furthermore, since the longitudinal biasing layer 20 can be made thicker corresponding to the depth to which the lower magnetic shield layer is dug, it becomes possible to apply an adequate longitudinal biasing. Still furthermore, digging the lower magnetic shield layer 11 by etching to give it a tapered depth, that is, into a continuously changing depth prevents generation of a discontinuous magnetic charge distribution in the lower magnetic shield layer 11. This makes it possible to provide a stable head whose reproducing performances do not fluctuate.

The insulator on the track-width sides 22, the longitudinal biasing layer 20, and a protection film on the track-width sides 23 are formed as shown in FIG. 7(c) so as to dispose them on both sides of the sensor portion where the upper gap layer 171, the magnetoresistive film, and the lower gap layer 12 have been etched. The liftoff mask is then removed as shown in FIG. 7(d).

For the lift-off process, a CMP (chemical mechanical polishing) method is used. The method, as compared with conventional methods, can reduce the height of the lift-off mask, so that the longitudinal biasing layer 20 is improved in coverage. As a result, as compared with cases where a conventional method is used, it becomes possible to form a thicker longitudinal biasing layer having a uniform thickness over a portion extending closer to the magnetoresistive film.

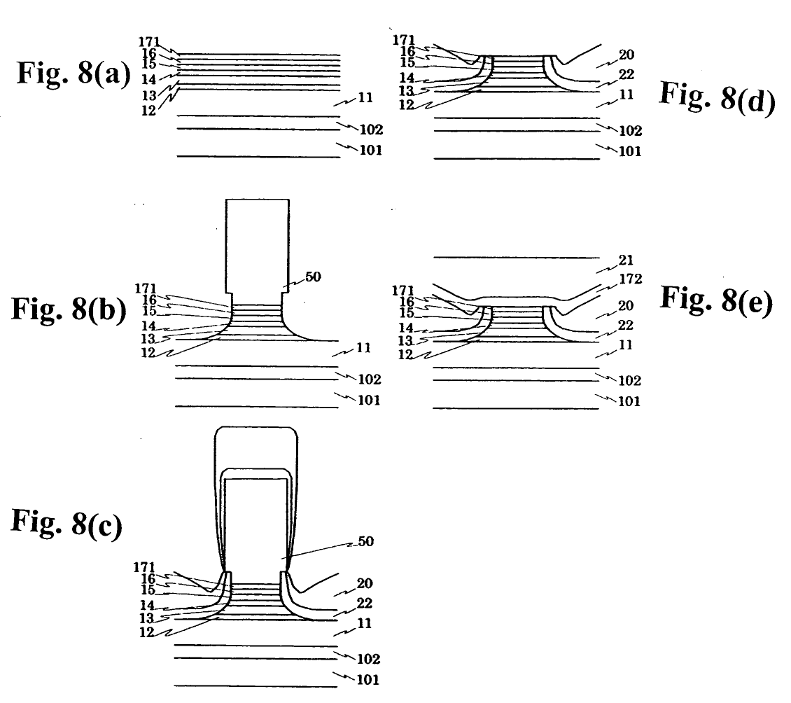

The reason why the lift-off mask 50 is required to be higher when a conventional method is used will be described below with reference to FIG. 8. In conventional methods, an arrangement is made to cause micro-cracks to be generated in the portions of the insulator on the track-width sides 22 and longitudinal biasing layer 20, where are on the side walls of the lift-off mask. This is to allow a remover to infiltrate through the micro-cracks and dissolve the lift-off mask 50. Thus, what is important is to generate micro-cracks in the films deposited on the side walls of the lift-off mask. Even if, in forming films, an arrangement is made such that particles to be deposited on the substrate surface come flying, to a maximum extent possible, in a direction perpendicular to the substrate plane, the particles each having a kinetic energy start migrating after reaching the substrate surface and end in depositing on the side walls of the lift-off mask. For the purpose of generating the micro-cracks, it is necessary to make the lift-off mask high not to allow the particles having reached the substrate surface to migrate to the side walls of the lift-off mask and form thick layers there. There are cases where, to enable the lift-off mask to be removed with higher yield, the insulator on the track-width sides 22 and longitudinal biasing layer 20 deposited on the side walls of the lift-off mask 50 are made partly discontinuous. The lift-off mask 50 formed as shown in FIG. 8(b) is designed to produce the above two effects. Namely, it is high while having a smaller width in a base portion. FIG. 8(c) shows that the layers, the insulator on the track-width sides 22 and longitudinal biasing layer 20, deposited on the side walls of the lift-off mask 50 are thin and that the layers deposited on the side walls are discontinuous in a base portion of the lift-off mask 50 where its width changes. The lift-off mask is dissolved and removed, as shown in FIG. 8(d), by a remover which is made to infiltrate through the micro-cracks formed in the layers deposited on the side walls of the lift-off mask. Consequently, a longitudinal biasing layer shown as “conventional structure 1” in FIG. 2(b) is formed as shown in FIG. 8(e).

The lift-off mask 50 is required to be high for the reasons as described above. When a layer, for example, the longitudinal biasing layer 20 is formed, however, the lift-off mask having a large height prevents particles to be deposited from being deposited in the vicinity of the high lift-off mask. This results in poor coverage of the layer.

When a conventional method is used, the lift-off mask 50 is required to have a height of at least 250 nm. When a lift-off method using CMP is used, a lift-off mask height of about 40 nm has been confirmed to enable a lift-off process.

For film formation, for example, to form the longitudinal biasing layer 20, a method such as an ion beam sputtering method capable of controlling the direction in which the particles to be deposited travel is used in many cases. To achieve satisfactory coverage in the vicinity of the magnetoresistive film, it is preferable that the particles to be deposited are incident in a range of 45 degrees with respect to the substrate normal. In this case, the coverage is the poorest at the incident angle of 45 degrees. Assuming that the lift-off mask is 40 nm high, the area where the particles to be deposited can reach without being blocked by the lift-off mask is, in an ideal condition, 40 nm or more away from the magnetoresistive film in the track width direction. With the particles to be deposited each having a kinetic energy, however, they migrate around on the substrate surface after having reached there, so that the coverage of the layer will not be as estimated for an ideal condition. Still, using the lift-off method to which CMP is applied according to embodiments of the present invention can improve the coverage.

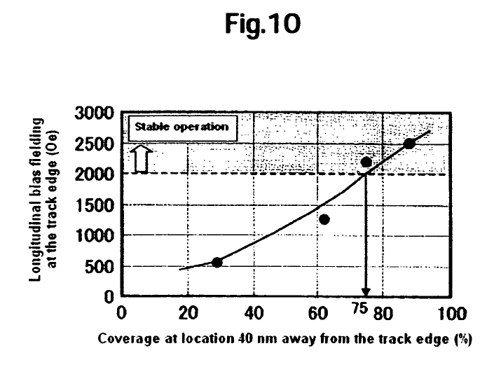

The results of a study made on relationships between the coverage of the longitudinal biasing layer 20 and the stability of read performance of the head will be described below with reference to FIG. 10. FIG. 10 shows the strength of the longitudinal bias field at an edge in the track width direction of the second ferromagnetic layer 16, calculated by a finite element method varying the value of a coverage parameter value. Here, the coverage parameter is represented by the ratio of the thickness of the longitudinal biasing layer 20 deposited at a location 40 nm away from a track edge (an edge of the free layer in the track width direction) to the thickness of the longitudinal biasing layer 20 at a location 2 nm away from the center of the read track width, where the layer is deposited without being affected by the lift-off mask 50. The calculation was made based on a read gap length of 40 nm, a track width of 80 nm, and a magnetic moment (360 G·μm) of the longitudinal biasing layer. The magnetic moment of 360 G·μm was assumed to be achieved in an area 2 μm or more away from the center of the read track width. Whereas, in an area closer to the track, the film thickness was assumed to change causing the coverage to also change. The film thickness of the longitudinal biasing layer 20 was assumed to change monotonously. Namely, in its portion extending from a location 40 nm away from a track edge to a location 2 μm away from the center of the read track width, the film thickness of the longitudinal biasing layer 20 was assumed to be minimum at the location 40 nm away from the track edge.

The read performance stability depends mainly on the state of magnetization of the free layer 16. To enable stable operation, the longitudinal biasing at the edge of the free layer 16 in the track width direction is required to be large. Based on the results of study so far made on read heads using a GMR element with a CIP structure and read heads using a TMR or CPP-GMR film with a CPP structure, it can be empirically said that, to enable stable operation, the longitudinal biasing is required to have a strength of at least 2000 Oe at an edge of the free layer 16 along the track width direction. The value is the same for the CIP heads and CPP heads. This can be explained as follows. The strength of the demagnetizing field at the edge of the free layer 16 along the track width direction becomes about the same between the two types of heads firstly because the saturation magnetization of the material used in the free layer 16 is approximately the same between the two types of heads and secondly because, from a viewpoint of shape anisotropy, the proportion among the track width, sensor-height, and film thickness cannot be largely changed.

It is shown that, as the coverage improves (i.e. as the coverage figure increases), the strength of the longitudinal bias field at the track edge of the free layer 16 increases. This is considered to be because improvement in the coverage reduces the magnetic charge density on the surface of the inclined-plane portion of the longitudinal biasing layer 20, causing the magnetic flux leaking into the upper magnetic shield layer or the lower magnetic shield layer to be reduced. It is shown that the field strength of 2000 Oe required to enable stable read operation is achieved when the coverage rises to or above 75%.

The insulator on the track-width sides 22 may be a single layer of alumina, silicon oxide, tantalum oxide, aluminum nitride, silicon nitride, or tantalum nitride, or a composite film or film stack of such elements. The longitudinal biasing layer 20 may be formed of a hard magnetic film of, for example, a Co—Pt alloy or Co—Cr—Pt alloy, or a laminate of a ferromagnetic film of, for example, a Ni—Fe alloy or Co—Fe alloy and an antiferromagnetic film of, for example, a Pt—Mn alloy or Mn—Ir alloy or a hard magnetic film of, for example, a Co—Pt alloy or Co—Cr—Pt alloy. When the longitudinal biasing layer 20 is formed of a hard magnetic film, a seed layer formed of, for example, Cr may be provided to control the properties, coercivity in particular, of the hard magnetic film.

The protection film on the track-width sides 23 is provided to prevent the longitudinal biasing layer 20 from being pared off during chemical mechanical polishing performed to remove the lift-off mask. It is formed of material, for example, C, Cr, Rh, or Ir which is not quickly ground by chemical mechanical polishing. The protection film on the track-width sides 23 is not necessarily required when the process margin is wide.

Even though, in the foregoing, an ion beam sputtering method was cited as an example method for forming the insulator on the track-width sides 22, longitudinal biasing layer 20, and protection film on the track-width sides 23, other methods such as a CVD (chemical vapor deposition) method and a DC or RF sputtering method may also be used.

After formation of the sensor portion in the track width direction is completed, the area to be the magnetoresistive sensor portion in the sensor height direction is covered with a lift-off mask, and unrequired portions, outside the magnetoresistive sensor portion for field detection, of the magnetoresistive film, insulator on the track-width sides 22, longitudinal biasing layer 20, and protection film on the track-width sides 23 are removed by etching. At this time, it is important, as in the process of formation in the track width direction, to take utmost care not to allow removed material to be redeposited on side walls of the magnetoresistive film. Subsequently, a layer for insulation in the sensor-height direction is formed, the insulator being a single layer film of alumina, silicon oxide, tantalum oxide, aluminum nitride, silicon nitride, or tantalum nitride, or a mixture or laminate of such elements. The lift-off mask is then removed to complete the sensor portion formation in the sensor-height direction.

Next, leads for supplying a sensing current to the lower magnetic shield layer 11 and upper magnetic shield layer 21 are formed. The leads are formed of a low resistive metal, for example, Cu, Au, Ta, Rh, or Mo. A different metal layer may be provided as required under and/or over the leads.

After an insulation protection film is formed as required, the surfaces of the magnetoresistive film and leads are cleaned, and then a second upper gap layer 172, which also serves as a seed layer for the upper magnetic shield layer 21, and the upper magnetic shield layer 21 are formed (FIG. 7(e)) to complete the process for producing the read head.

Over the read head, an inductive head for writing is formed with a read-write separator interposed for separation between the read head and the write head. Details in this regard are omitted in the present specification. After the inductive head is formed, the read head is annealed while a magnetic field is applied in the track width direction of the read head so as to align the direction of magnetization of the free layer 16 with the track width direction while keeping the direction of magnetization of the pinned layer 14 approximately aligned with the sensor-height direction. This completes the wafer process.

The subsequent processes performed before a head gimbal assembly is completed include a lapping process in which the magnetic head element is mechanically lapped until it has a desired height, a protection film formation process for forming a protection film to protect the read head and the write head in a magnetic storage apparatus, an air bearing process in which a rail for controlling the spacing (flying height) between the magnetic head and the disk is formed in a predetermined shape on the air bearing surface, and an assembling process in which the magnetic head is bonded to a suspension.

The head structure of the magnetic head on the air bearing surface according to the embodiments of present invention, as shown in FIG. 1, has the following features:

(1) The edge of the longitudinal biasing layer facing the sensor film, on each side, is positioned, as seen in the track width direction, outside the edge, on the corresponding side of the free layer 16, in the track width direction.

(2) The underside of the longitudinal biasing layer 20 is positioned lower than the underside of the sensor film in areas away from the sensor film in the track width direction.

(3) Portions extending closely to the sensor film of the longitudinal biasing layer 20 are approximately uniformly thick.

(4) The side walls of the sensor film in the track width direction are concavely shaped, and the interface between the lower magnetic shield layer 11 and the insulator on the track-width sides 22 on each side of the sensor film is gently concave with an inclination continuous to the concavely shaped side wall of the sensor film on the corresponding side.

(5) Edges of the free layer in the track width direction each have an upwardly convex upper contour and a downwardly convex lower contour in the vicinity of the sensor film.

Magnetic heads having a tunneling barrier as an intermediate layer 15 were produced, and the head performance, and read performance in particular, were evaluated. The magnetic heads had a track width (geometric width of a free layer 16) of 80 nm and a read gap length of 40 nm. The hard magnetic layer included in them as the longitudinal biasing layer 20 had the product of a residual magnetic flux density Br and a film thickness t being eight times the product of the saturate magnetic flux density Bs and film thickness t of the free layer. The magnetic heads had a sensor-height of about 80 nm. They each had a lower magnetic shield layer 11 which was dug by 10 nm, at a location 2 μm away from the center of the track width, relative to the height of the track center. The film thickness of their longitudinal biasing layer 20 at a location 40 nm away from a track edge was equivalent to 88% of their film thickness at a location 2 μm away from the track center.

For comparison with the above magnetic heads, magnetic heads in which structure along the track width direction was formed by a conventional method were also produced. Their structure on the air bearing surface portion was structured as shown in FIG. 2(b).

Five hundreds each of the magnetic heads produced according to embodiments of the present invention and those produced by a conventional method were compared using a spin stand as to an output Vₚₚ obtained when predetermined recorded signals were read and an amplitude fluctuation dVₚₚ observed by turning a predetermined write current on and off repeatedly. Results of the comparison are shown in Table 1. The amplitude fluctuation dVₚₚ is defined as: dVₚₚ=(Vₘₐₓ−Vₘᵢₙ)/Vₐᵥₑ×100(%) where Vₘₐₓ represents a maximum output value, Vₘᵢₙ a minimum output value, and Vₐᵥₑ an average output value. In calculating the output Vₚₚ yields shown in Table 1, magnetic heads with an output Vₚₚ of 4.5 mV or higher were judged a pass. In calculating the amplitude fluctuation dVₚₚ yields, magnetic heads with an amplitude fluctuation dVₚₚ of 10% or lower were judged a pass.

TABLE 1

| | Output Vₚₚ | Amplitude fluctuation |
|---|---|---|
| | yield | dVₚₚ yield |
| Head according to embodiments of | 95% | 90% |
| the invention | | |
| Comparative examples | 98% | 43% |
| (conventional heads) | | |

As for the output Vₚₚ, the comparative examples with a yield of 98% were superior to the magnetic heads of embodiments of the present invention, with a yield of 95%. As for the amplitude fluctuation dVₚₚ yield, however, the magnetic heads of embodiments of the present invention with a yield of 90% were by far superior to the comparative examples with a yield of 43%. Based on these results, the comparative examples may be considered to have shown a high yield for the output Vₚₚ and a low yield for the amplitude fluctuation dVₚₚ that represents the read performance stability on account of a weak longitudinal biasing. The magnetic heads of embodiments of the present invention, on the other hand, may be considered to have shown a good yield for both the output Vₚₚ and the amplitude fluctuation dVₚₚ thanks to a longitudinal biasing of an appropriate strength.

Using the same method as used to produce the magnetic heads of embodiments of the present invention (evaluated) as described above, more magnetic heads were produced, their lower magnetic shield layers 11 having been etched to varied extents (dug to varied depths) in the process for forming the head structure along the track width direction. The magnetic heads were evaluated in the same way as used for the above described evaluation. The evaluation results are shown in Table 2.

TABLE 2

| | Center of | | |
|---|---|---|---|
| | longitudinal biasing | | Amplitude |
| Digging depth in | layer height - Center | | fluctuation |
| lower magnetic | of free layer height | Output Vₚₚ | dVₚₚ yield |
| shield layer (nm) | (nm) | yield (%) | (%) |
| −3 | 14 | 98% | 74% |
| 0 | 9 | 97% | 81% |
| 6 | 3 | 95% | 90% |
| 10 | 1 | 95% | 90% |
| 12 | 0 | 94% | 93% |

In Table 2, the depth of digging in the lower magnetic shield layer 11 represented by a positive number indicates that the lower magnetic shield layer 11 was dug by etching. The depth of digging represented by a negative number indicates that the lower magnetic shield layer 11 was not dug, for example, with the lower gap layer 12 partly left over it. In Table 2, the second column from left shows the balance between the height of the thickness center of the longitudinal biasing layer 20 and the height of the thickness center of the free layer 16. When the balance is positive, the thickness center of the longitudinal biasing layer 20 is higher than the thickness center of the free layer 16. In the evaluation process, the average height of the thickness center from an edge of the longitudinal biasing layer 20 facing the sensor film to the position 2 μm away from the center of the read track width, was used as the height of the thickness center of the longitudinal biasing layer 20. It is known from Table 2 that, when the lower magnetic shield layer 11 is dug more, the height of the thickness center of the longitudinal biasing layer 20 is reduced more to approach the height of the thickness center of the free layer 11 and that, as a result, the longitudinal biasing is strengthened to suppress the output, causing the Vₚₚ yield to decrease and the dVₚₚ yield to increase. When the lower magnetic shield layer 11 is dug by 6 nm, a portion closest to the substrate of the interface between the longitudinal biasing layer 20 and the insulator on the track-width sides 22 becomes lower than the interface between the lower gap layer 12 and the lower magnetic shield layer 11. The magnetic heads with the lower magnetic shield layer 11 dug by 6 nm or more showed as high a yield as 90% or more for both the Vₚₚ and dVₚₚ.

### Embodiment 2

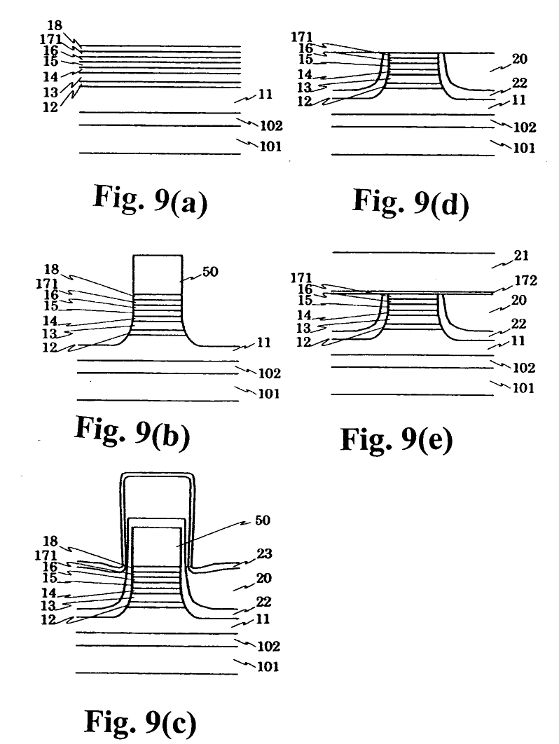

A high recording density can be achieved by narrowing the physical track width, but it is also important to narrow the magnetic track width. To narrow the magnetic track width, it is necessary to narrow not only the read gap length at the location where the magnetoresistive film is positioned, but also the shield-to-shield distance on both sides of the magnetoresistive film. FIG. 6 shows the structure of a magnetoresistive head along the track width direction according to embodiments of the present invention, meeting the above requirement. FIG. 9 shows a process flow scheme for forming the head structure along the track width direction.

In Embodiment 1, the underside of the upper magnetic shield layer 21 is downwardly convex with a bottom formed over the magnetoresistive sensor portion and the distance between the upper magnetic shield layer 21 and the lower magnetic shield layer 11 widened on both sides of the magnetoresistive film. It is possible to make the top surface of the magnetoresistive film and the top surface of the longitudinal biasing layer 20 approximately identically positioned heightwise (FIG. 9(d)) in a state after the CMP process while, in the CMP process, preventing the longitudinal biasing layer 20 from being pared off in the vicinity of the magnetoresistive film in particular. Namely, it can be done by: forming the process protection film on a magnetoresistive film 18 thinly as shown in FIG. 9(a); digging the lower magnetic shield layer 11 to a slightly increased depth by etching performed to form the head structure along the track width direction as shown in FIG. 9(b); thinning the track width direction protection layer 23 as shown in FIG. 9(c); and reducing the difference in height between the magnetoresistive film and the portions on its both sides just before the CMP process for removing the lift-off mask. Proceeding as described above makes it possible to flatten the underside of the upper magnetic shield layer 21. Since the shield-to-shield distance can be reduced on both sides of the magnetoresistive film, the magnetic track width can be narrowed. It must be noted that the conditions for the CMP process for removing the lift-off mask require to be changed from the conditions applied for structure formation in Embodiment 1. It is necessary to optimize the conditions so that the process protection film on a magnetoresistive film 18 or the first upper gap layer 171 is partly left and so that the partly left layer is approximately as high as the longitudinal biasing layer 20.

Furthermore, by thinning the second gap layer 172 as shown in FIG. 9(e), the read gap length in the magnetoresistive film portion can also be reduced, so that the areal density can be increased not only in the track width direction but also in the bit length direction.

More magnetic heads with a track width (geometric width of a free layer 16) of 80 nm and a read gap length of 30 nm were produced. The hard magnetic layer included in them as a longitudinal biasing layer 20 had the product of a residual magnetic flux density Bᵣ and a film thickness t being eight times the product of the saturation magnetic flux density Bₛ and film thickness t of the free layer. The magnetic heads had a sensor-height of about 80 nm. Their lower magnetic shield layers 11 were dug to varied depths. The magnetic heads were subjected to evaluation similar to the evaluation made for Embodiment 1. The evaluation results are shown in Table 3.

TABLE 3

| | Center of | | |
|---|---|---|---|
| | longitudinal biasing | | Amplitude |
| Digging depth in | layer height - Center | | fluctuation |
| lower magnetic | of free layer height | Output Vₚₚ | dVₚₚ yield |
| shield layer (nm) | (nm) | yield (%) | (%) |
| −3 | 23 | 99% | 60% |
| 0 | 17 | 99% | 69% |
| 6 | 8 | 97% | 83% |
| 10 | 4 | 96% | 88% |
| 12 | 3 | 95% | 90% |

When the lower magnetic shield layer 11 is dug by 6 nm or more, a portion closest to the substrate of the interface between the longitudinal biasing layer 20 and the insulator on the track-width sides 22 becomes lower than the interface between the lower gap layer 12 and the lower magnetic shield layer 11. The magnetic heads produced for this evaluation had a small read gap length, 30 nm, so that the magnetic flux generated by the longitudinal biasing layer 20 was inclined to leak into the lower or upper magnetic shield layer. Hence, their dVₚₚ yields were lower than the corresponding figures shown by the evaluation results (Table 2) for Embodiment 1. The magnetic heads with the lower magnetic shield layer 11 dug by 6 nm or more, however, showed a high dVₚₚ yield, 80%. This indicates that the dVₚₚ yield can be raised to 90% or more by digging the lower magnetic shield layer 11 more deeply.

The magnetoresistive film described in the foregoing has an intermediate layer which is a barrier layer and which makes use of a TMR effect or an intermediate layer which is a conductive layer possibly provided with a current-confined-path layer and which makes use of a CPP-GMR effect. The intermediate layer, however, is not limited to such types. It may be one using a magnetic semiconductor or making use of polarized spin diffusion and accumulation phenomena. The effects of embodiments of the present invention can be obtained as long as a sensing current is made to flow through the stacking surface of the magnetoresistive film used in the magnetic head. The magnetoresistive film may be formed of a multilayered CPP-GMR film including multiple magnetic layers and conductive layers. The lower gap layer 12, the first upper gap layer 171, and the second upper gap layer 172 are not indispensable. They need not be provided when not required by the sensor structure or sensor production process to be used. The process protection film on a magnetoresistive film 18 is removed after the lift-off mask is removed. It, however, need not be necessarily removed. It may be left unremoved, since using a metallic material enables a sensing current to flow through the magnetoresistive film.

Even though, in the above, a head production method in which a magnetic head structure along the track width direction is formed first has been described as an example, using a head production method in which a magnetic head structure along the sensor-height direction is formed first does not at all affect the effects of embodiments of the present invention. Even though the magnetoresistive head described above has a magnetoresistive film exposed on the air bearing surface, the same effects of embodiments of the present invention can be obtained also by using a magnetoresistive head having a magnetoresistive film which, being disposed apart from the air bearing surface, is not at all exposed or only partly exposed on the air bearing surface.

Embodiments of the present invention can provide a magnetoresistive head in which instability phenomena, for example, Barkhausen noise attributable to unstable magnetization operation are suppressed and which excels in read performance stability.

What is claimed is:

1. A magnetoresistive head, comprising:
a lower magnetic shield layer;
an upper magnetic shield layer;
a magnetoresistive film which is formed between the lower magnetic shield layer and the upper magnetic shield layer and which includes a film stack including a pinned layer, an intermediate layer, and a free layer; and
a longitudinal biasing layer formed, via an insulator, on each side of the sensor film in a track width direction; the head being characterized in that:
an edge facing the sensor film of the longitudinal biasing layer is positioned outer in the track width direction than an edge in the track width direction of the free layer,
an underside of the longitudinal biasing layer is, in an area separated from the sensor film in the track width direction, positioned lower than an underside of the sensor film, and
a sensing current is made to flow in a direction perpendicular to a plane of the sensor film.

2. The magnetoresistive head according to claim 1, characterized in that the longitudinal biasing layer is approximately uniform in thickness over a portion thereof extending to a vicinity of the sensor film.

3. The magnetoresistive head according to claim 1, characterized in that: a side all in the track width direction of the sensor film has a concave shape; and an interface between the lower magnetic shield layer and the insulator is gently concave with an inclination continuous to the (said) concave shape.

4. A magnetoresistive head according to claim 1, characterized in that, in a portion thereof extending from a location 2 μm away from a track width center of the free layer to a location 40 nm away from an edge of the free layer along the track width direction, a minimum thickness of the longitudinal biasing layer is at least 75% of a maximum thickness of the longitudinal biasing layer.

5. The magnetoresistive head according to claim 4, characterized in that the longitudinal biasing layer has, in a portion thereof closer to the sensor film than a location thereof 40 nm away from an edge of the free layer in the track width direction, an upwardly convex upper contour and a downwardly convex lower contour.

6. The magnetoresistive head according to claim 4, characterized in that an underside of the upper magnetic shield layer is, on an air bearing surface thereof, approximately flat an linear.

7. A magnetoresistive head, comprising:
a lower magnetic shield layer;
an upper magnetic shield layer;
a magnetoresistive film which is formed between the lower magnetic shield layer and the upper magnetic shield layer and which includes a film stack including a pinned layer, an intermediate layer, and a free layer; and
a longitudinal biasing layer formed, via an insulator, on each side of the sensor film, in a track width direction; the head being characterized in that:
a side wall of the sensor film in the track width direction is concave,
an edge facing the sensor film of the longitudinal biasing layer is positioned outer in the track width direction than an edge of the free layer in the track width direction,
in an area separated from the sensor film in the track width direction, an underside of the insulator is positioned lower than an underside of the sensor film,
an interface between the lower magnetic shield layer and the insulator is gently concave with an inclination continuous to the concave shape of the side wall in the track width direction of the sensor film, and
a sensing current is made to flow in a direction perpendicular to a plane of the sensor film.

8. The magnetoresistive head according to claim 7, characterized in that, in a portion thereof extending from a location 2 μm away from a track width center of the free layer to a location 40 nm away from an edge of the free layer along the track width direction, a minimum thickness of the longitudinal biasing layer is at least 75% of a maximum thickness of the longitudinal biasing layer.

9. The magnetoresistive head according to claim 8, characterized in that the longitudinal biasing layer has, in a portion thereof closer to the sensor film than a location thereof 40 nm away from an edge of the free layer in the track width direction, an upwardly convex upper contour and a downwardly convex lower contour.

10. A magnetoresistive head, comprising:
a lower magnetic shield layer;
an upper magnetic shield layer;
a magnetoresistive film which is formed between the lower magnetic shield layer and the upper magnetic shield layer and which includes a film stack including a pinned layer, an intermediate layer, and a free layer; and
a longitudinal biasing layer formed, via an insulator, on each side of the sensor film, in a track width direction; the head being characterized in that:
an edge facing the sensor film of the longitudinal biasing layer is positioned outer in the track width direction than an edge in the track width direction of the free layer,
in an area separated from the sensor film in the track width direction, an underside of the longitudinal biasing layer is positioned lower than an underside of the sensor film,
the longitudinal biasing layer has, over an edge thereof extending toward the sensor film from a location thereof 40 nm away from an edge of the free layer in the track width direction, an average height which does not differ more than 8 nm from an average height of the free layer, and
a sensing current is made to low in a direction perpendicular to a plane of the sensor film.

11. The magnetoresistive head according to claim 10, characterized in that the longitudinal biasing layer is approximately uniform in thickness over a portion thereof extending to a vicinity of the sensor film.

12. The magnetoresistive head according to claim 10, characterized in that: a side wall of the sensor film in the track width direction ahs a concave shape; and an interface between the lower magnetic shield layer and the insulator is gently concave with an inclination continuous to the (said) concave shape.

13. The magnetoresistive head according to claim 10, characterized in that, in a portion thereof extending from a location 2 μm away from a track width center of the free layer to a location 40 nm away from an edge of the free layer along the track width direction, a minimum thickness of the longitudinal biasing layer is at least 75% of a maximum thickness of the longitudinal biasing layer.

14. The magnetoresistive head according to claim 13, characterized in that the longitudinal biasing layer has, in a portion thereof closer to the sensor film than a location thereof 40 nm away from an edge of the free layer in the track width direction, an upwardly convex upper contour and a downwardly convex lower contour.

15. The magnetoresistive head according to claim 13, characterized in that an underside of the upper magnetic shield layer is, on an air bearing surface thereof, approximately flat and linear.
